(19) United States
(12) Patent Application Publication
(10) Pub. No.: US 2006/0099535 A1
(43) Pub. Date: May 11, 2006

(54) Pattern forming method and pattern forming apparatus

(75) Inventor: Manabu Yabe, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/222,736

(22) Filed: Sep. 12, 2005

(30) Foreign Application Priority Data
Nov. 10, 2004 (JP) P2004-326153

(51) Int. Cl. B05D 5/00; B05C 5/00; G03C 5/00

(52) U.S. Cl. 430/322; 427/256; 118/313

(57) ABSTRACT

A pattern forming apparatus (1) comprises an ejection part (41) for ejecting a patterning material to a main surface of a substrate (9) from a plurality of outlets. The ejection part (41) moves relative to the substrate (9) in a direction along the main surface of the substrate (9) by a stage moving mechanism (2) and a plurality of linear pattern elements are formed on the substrate (9). In forming the linear pattern elements, moving speed of the plurality of outlets relative to the substrate (9) is changed periodically by an outlets moving mechanism (44) and gnarl portions each of which spreads in a direction perpendicular to a direction extending the linear pattern elements (91) are formed in each linear pattern element (91). This makes it possible to form a pattern similar to parallel crosses on the substrate 9 appropriately while ejecting the patterning material from the plurality of outlets.

### BACKGROUND OF THE INVENTION

1. Field of the Invention

The present invention relates to a technique for forming a pattern on a substrate.

2. Description of the Background Art

Sandblasting (which is also called “photolithography”), screen-printing, a lift-off process, and the like have conventionally been known as techniques for forming a rib pattern (arrangement of ribs) in a panel for a plasma display. However, the above-cited techniques are complicated and thus manufacturing costs increase.

In the foregoing situations, a technique such as disclosed in Japanese Patent Application Laid Open Gazette No. 2002-184303 (Document 1) has been developed in recent years. According to the new technique, a paste-like patterning material containing a light-curing resin is ejected from a nozzle having small outlets to a substrate to form a rib pattern of stripes on the substrate, and thereafter, ultraviolet rays are applied to the patterning material to cure the patterning material. This new technique simplifies a process for forming a rib pattern and allows more efficient use of the patterning material, to thereby reduce manufacturing costs for a panel.

According to a technique disclosed in Japanese Patent Application Laid Open Gazette No. 2003-187694, in a pattern forming apparatus which ejects a patterning material from a nozzle and forms a pattern on a substrate, an oscillating mechanism for oscillating the nozzle to a direction perpendicular to moving direction of the substrate is provided and a rib pattern of periodic waveforms is formed on the substrate.

For a panel used in a plasma display, ribs on a substrate are arranged in a pattern of stripes or parallel crosses in most cases. To arrange ribs in a pattern of stripes is advantageous in that manufacture is relatively easy because of simplicity of a structure thereof and that each of cells (light emitting areas) can be exhausted in a relatively short time in supplying gas necessary for light emission to each of the cells, in one aspect. However, to arrange ribs in a pattern of stripes would require provision of a non-light emitting area. Also, a surface area of a phosphor in each of the cells in a case where ribs are arranged in a pattern of stripes is smaller than in a case where ribs are arranged in parallel crosses. As such, a panel including ribs arranged in a grid pattern is more useful for improving a brightness of a plasma display. In the method of Document 1, it is possible to form a pattern of stripes easily, but difficult to form a pattern of parallel crosses.

### SUMMARY OF THE INVENTION

The present invention is intended for a pattern forming method for forming a pattern on a substrate. It is an object of the present invention to form a pattern similar to parallel crosses on a substrate appropriately while ejecting a patterning material from a plurality of outlets.

The pattern forming method comprises the steps of a) ejecting a patterning material from a plurality of outlets to a main surface of a substrate, b) forming a plurality of linear pattern elements each of which extends in a predetermined direction along the main surface by moving the plurality of outlets relative to the substrate in the predetermined direction in parallel with the step a), and c) forming gnarl portions in each of the plurality of linear pattern elements in parallel with the step b), each of the gnarl portions spreading in a direction perpendicular to the predetermined direction, and in the method, a plurality of gnarl portions arranged in a direction perpendicular to the predetermined direction in the plurality of linear pattern elements are formed at almost the same time at every specified time interval in forming the plurality of linear pattern elements in the step c).

According to the present invention, it is possible to form a pattern similar to parallel crosses on the substrate appropriately while ejecting the patterning material from the plurality of outlets.

According to one preferred embodiment of the present invention, in the method, outlet flow speed of the patterning material from each of the plurality of outlets is constant in the step a), moving speed of the plurality of outlets relative to the substrate is changed periodically in the step c), and thereby a ratio of the outlet flow speed of the patterning material to the moving speed of the plurality of outlets is changed so that the plurality of gnarl portions are formed easily.

According to another preferred embodiment of the present invention, in the method, the moving speed of the plurality of outlets is constant in the step b), the outlet flow speed of the patterning material is changed periodically in the step c), and thereby the ratio of the outlet flow speed of the patterning material to the moving speed of the plurality of outlets is changed so that the plurality of gnarl portions are formed easily.

According to still another preferred embodiment of the present invention, in the method, the pattering material contains a light-curing resin, by performing ON/OFF control of light irradiation to the patterning material ejected to the substrate, an irradiation intensity of light to the patterning material which has just been ejected to the substrate is changed periodically in the step c), and the plurality of gnarl portions are formed easily.

The invention is also intended for a pattern forming apparatus for forming a pattern on the substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a constitution of a pattern forming apparatus;

FIG. 2 is a view showing the vicinity of an ejection part;

FIG. 3 is an enlarged view showing the vicinity of an end portion of a nozzle;

FIG. 4 is a flow chart showing an operation flow for forming a pattern on a substrate;

FIG. 5 is a graph showing change of moving speed of outlets relative to the substrate and change of position of the outlets relative to a support part;

FIG. 6 is a plan view showing a plurality of linear pattern elements on the substrate;

FIG. 7 is a longitudinal sectional view showing the linear pattern elements;

FIG. 8 is a plan view showing linear pattern elements arranged in a pattern of stripes;

FIG. 9 is a view showing a constitution of a diaphragm part;

FIG. 10 is a flow chart showing an operation flow for forming a pattern on a substrate;

FIG. 11 is a plan view showing a plurality of linear pattern elements on the substrate;

FIG. 12 is a view showing an irradiation intensity change part;

FIG. 13 is a flow chart showing an operation flow for forming a pattern on a substrate;

### DESCRIPTION OF THE PREFERRED EMBODIMENTS

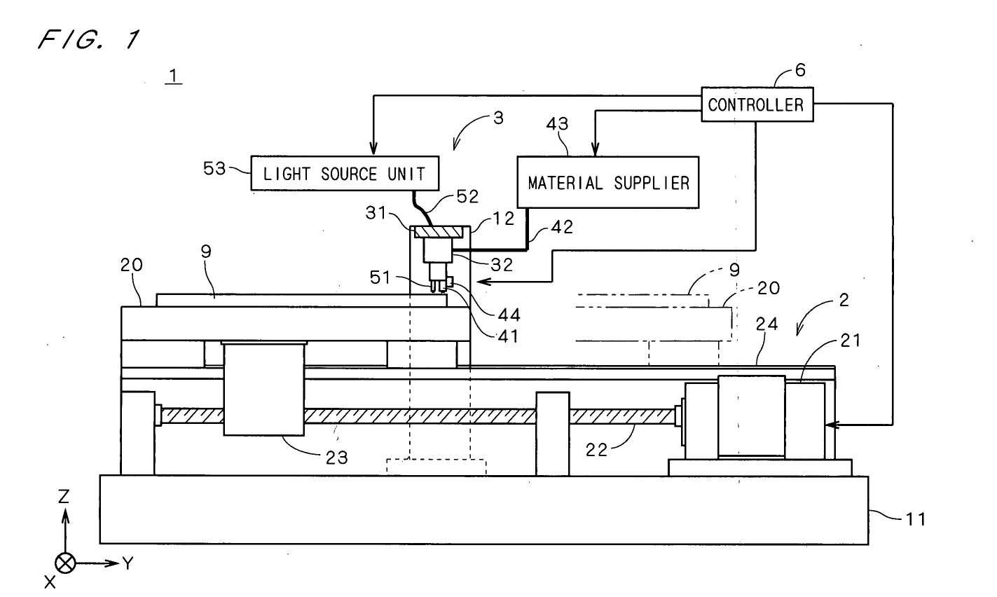

FIG. 1 is a view showing a constitution of a pattern forming apparatus 1 in accordance with the first preferred embodiment of the present invention. The pattern forming apparatus 1 is an apparatus for forming a pattern corresponding to a plurality of ribs on a glass substrate (hereinafter, referred to as “substrate”) 9 for a plasma display, and the substrate 9 on which the pattern is formed becomes a panel (usually, rear panel) which is a subassembly of plasma display through other process(es).

The pattern forming apparatus 1 includes a stage moving mechanism 2 provided on a base part 11. Then, a stage 20 for holding the substrate 9 is allowed to move along a main surface of the substrate 9, i.e., in the Y direction shown in FIG. 1 by the stage moving mechanism 2. Further, a frame 12 is secured to the base part 11 so as to cross over the stage 20. Moreover, a head 3 is attached to the frame 12.

The stage moving mechanism 2 includes a motor 21 connected with a ball screw 22, and further includes a nut 23 which is secured to the stage 20 and connected to the ball screw 22. Guide rails 24 are fixedly provided above the ball screw 22. With this structure, rotation of the motor 21 causes the stage 20, together with the nut 23, to smoothly move along the guide rails 24, i.e., in the Y direction.

The head 3 includes an ejection part 41 for ejecting a paste-like patterning material containing a light-curing resin (a resin which cures in response to application of ultraviolet rays in the present preferred embodiment) to the main surface (hereinafter also referred to as “top surface”) of the (+Z) side of the substrate 9 and a light emitting part 51 for emitting ultraviolet rays toward the ejected patterning material. The ejection part 41 and the light emitting part 51 are attached to a support part 32 and the support part 32 is secured to the frame 12 with a base 31 interposed therebetween. The light-curing resin contained in the patterning material may be other than the resin which cures in response to application of ultraviolet rays, and in this case, light from the light emitting part 51 corresponds to the properties of the light-curing resin.

The ejection part 41 is connected with a supply pipe 42 for supplying the patterning material. The supply pipe 42 is connected to a material supplier 43. The patterning material contains a mixture of a low-melting glass frit as a main ingredient and a light-curing resin, which further contains a solvent, an additive, and the like. The light emitting part 51 is connected to a light source unit 53 for producing an ultraviolet ray, with an optical fiber 52 interposed therebetween.

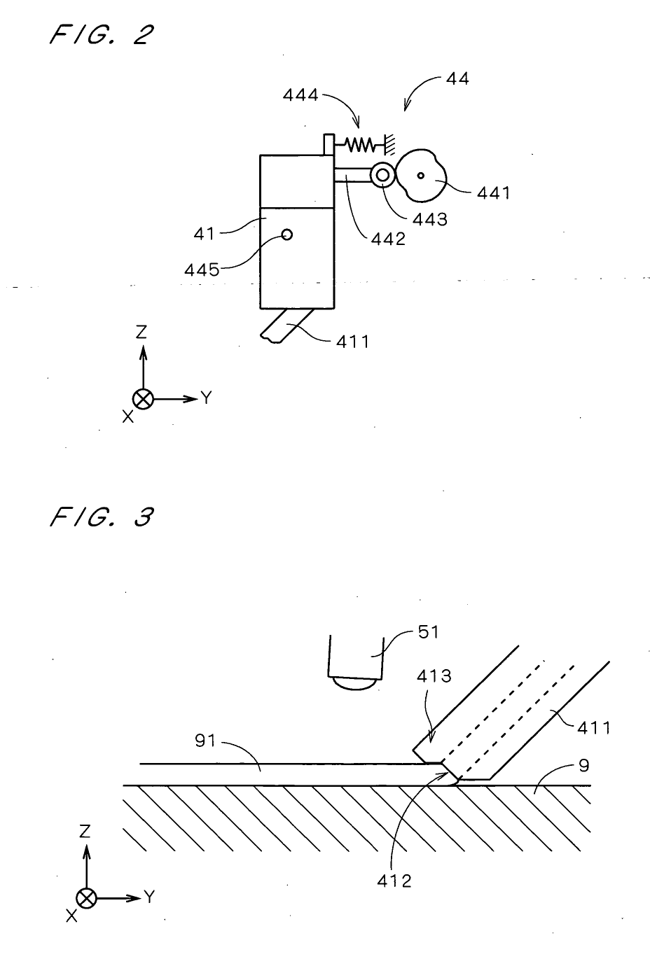

FIG. 2 is a view showing the vicinity of the ejection part 41, as seen from the (−X) side toward the (+X) direction. As shown in FIG. 2, a nozzle 411 is provided to lower portion of the ejection part 41, in an end portion of the nozzle 411, a plurality of outlets are formed to be arranged in the X direction perpendicular to the moving direction of the substrate 9. An outlets moving mechanism 44 is attached to the ejection part 41 and the outlets moving mechanism 44 rotates slightly (by a little angle) the ejection part 41 around an axis parallel to the X direction. The outlets moving mechanism 44 comprises a cam 441 equipped with a motor (not shown). A support part bar 442 is fixed to the ejection part 41, and a roller 443 which is attached to an end portion of the support part bar 442 is in contact with the circumference of the cam 441. A biasing mechanism 444 for biasing the roller 443 to the cam 441 (i.e., the (+Y) side) is attached to the ejection part 41. By rotation of the cam 441, the roller 443 moves in the Y direction, the ejection part 41 rotates around an axis 445 parallel to the X direction slightly, and the plurality of outlets of the end portion of the nozzle 411 move in the Y direction slightly. The end portion of the nozzle 411 is not in contact with the substrate 9 for slight rotation of the ejection part 41 by the outlets moving mechanism 44.

FIG. 3 is an enlarged view of the vicinity of the end portion of the nozzle 411 which is observed in the course of formation of a pattern. As shown in FIG. 3, the plurality of outlets 412 arranged in the X direction are formed in the end portion of the nozzle 411 (only one outlet 412 is shown in FIG. 3) and the patterning material is ejected from each of the outlets 412. In the nozzle 411, a projecting member 413 which projects out to the (−Y) side from the vicinity of the outlets 412 in the upper side ((+Z) side) of the plurality of outlets 412 is provided and the projecting member 413 is in contact with a top of the patterning material on the substrate 9 ejected from the outlets 412. The light emitting part 51 is located in the (−Y) side relative to the nozzle 411 so that light emitted from the light emitting part 51 is applied to the patterning material ejected from the outlets 412.

Referring back to FIG. 1, the pattern forming apparatus 1 further comprises a controller 6 which is connected with the stage moving mechanism 2, the material supplier 43, the outlets moving mechanism 44, and the light source unit 53. Then, the controller 6 controls the foregoing elements such that a pattern of arranged ribs are formed on the substrate 9.

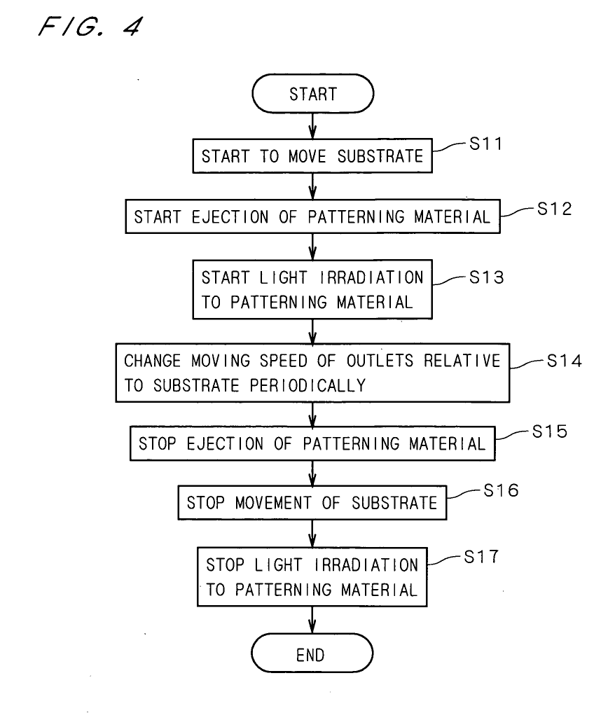

FIG. 4 is a flow chart showing an operation flow of the pattern forming apparatus 1 for forming a pattern on the substrate. In the pattern forming apparatus 1, first, the stage moving mechanism 2 is controlled by the controller 6 shown in FIG. 1 and the substrate 9, together with the stage 20, starts to move in the (−Y) direction from a position indicated by double-dashed lines in FIG. 1 (step S11). When the nozzle 411 of the ejection part 41 reaches a starting point for formation of pattern on the substrate 9, ejection of the patterning material from each of the plurality of outlets 412 is started (step S12). At this time, an outlet flow speed (outlet flow volume per unit time) of the patterning material from each outlet 412 is kept constant. Then, a shutter (not shown) provided in the light source unit 53 is opened, and light irradiation (ultraviolet rays) by the light emitting part 51 to the patterning material which has just been ejected to the substrate 9 is started (step S13).

In the pattern forming apparatus 1, as shown in FIG. 3, a plurality of linear pattern elements 91 (i.e., a plurality of continuous pattern elements and only one linear pattern element 91 is shown in FIG. 3) are sequentially formed from the (−Y) side toward the (+Y) direction of the substrate 9, by moving (scanning) the ejection part 41 relative to the substrate 9 in the (+Y) direction along the main surface of the substrate 9 in parallel with ejection of the patterning material from the ejection part 41. The linear pattern elements (the patterning material) which have just been ejected to the substrate 9 are cured by irradiation of light from the light emitting part 51.

In the pattern forming apparatus 1, while moving the substrate 9, the ejection part 41 rotates slightly according to the circumferential shape of the cam 441 by the outlets moving mechanism 44 and position of the plurality of outlets 412 shifts in the Y direction (the moving direction relative to the substrate 9) relative to the support part 32 of the head 3 as shown in the lower position of FIG. 5. Accordingly, moving speed of the plurality of outlets 412 relative to the substrate 9 which moves at a constant speed V1 continuously by the stage moving mechanism 2 is also changed periodically as shown in the upper part of FIG. 5 (step S14). Moving speed of the outlets 412 relative to the substrate 9 shown in the upper part of FIG. 5 shows a waveform made by overlapping two sine curves of different wave lengths.

In the first preferred embodiment, the value V2 shown in the upper part of FIG. 5 which is the maximum value of moving speed of the plurality of outlets 412 relative to the substrate 9 is set to be 4 mm per second, and pressure of the patterning material in the ejection part 41 is regulated so that the outlet flow speed of the patterning material from each outlet 412 is approximately equal to an amount which is obtained by multiplying the (relative) moving speed V2 by an area of the outlet 412 seen from the (−Y) side toward the (+Y) direction (i.e., a projected area of the outlet 412 on a plane parallel to the ZX plane). As mentioned above, since the outlet flow speed of the patterning material from each outlet 412 is constant, while moving speed of the outlets 412 relative to the substrate 9 is smaller than V2, the patterning material ejected to the substrate 9 is limited at a certain height by the projecting member 413 and spreads in the X direction perpendicular to the moving direction of the substrate 9. The width of the patterning material spreading in the X direction becomes maximum width at a minimum value V3 of (relative) moving speed.

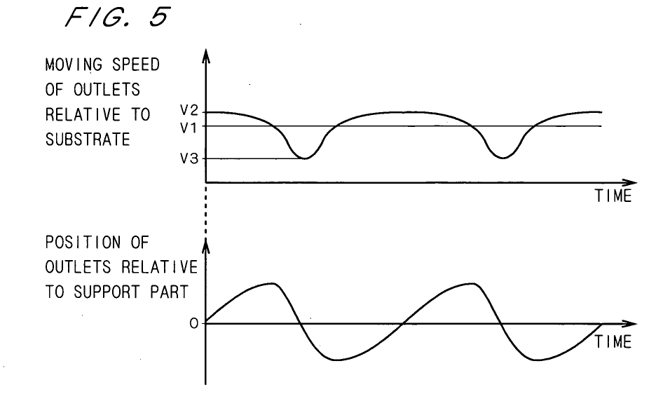

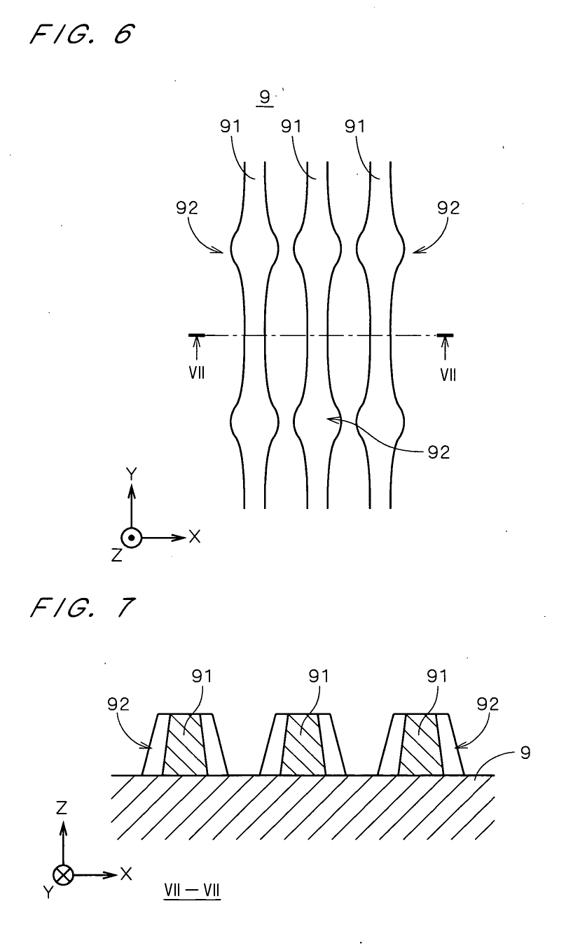

In other words, a ratio of outlet flow speed of the patterning material from each outlet 412 to moving speed of the plurality of outlets 412 relative to the substrate 9 is changed (i.e., a ratio of outlet flow volume of the patterning material from each outlet 412 to moving distance of the plurality of outlets 412 relative to the substrate 9 is changed.). By this operation, as shown in FIG. 6, gnarl portions each of which spreads in the direction (the X direction) perpendicular to the moving direction of the substrate 9 are arranged in the Y direction at a predetermined pitch in each of the plurality of linear pattern elements 91. In the plurality of linear pattern elements 91, the plurality of gnarl portions 92 which are formed at almost the same time in forming the plurality of linear pattern elements 91 exist in almost the same position of the Y direction (i.e., arranged in the X direction), and therefore a pattern similar to parallel crosses (grid pattern) is formed on the substrate 9 by one movement of the ejection part 41 relative to the substrate 9. Period of change of moving speed of the outlets 412 relative to the substrate 9 is adjusted so that the gnarl portions 92 exist in the Y direction at a pitch about 840-μm. A pitch of the linear pattern elements 91 in the X direction is about 280-μm, which is the same as that of the plurality of outlets 412 in the X direction.

FIG. 7 is a longitudinal sectional view showing the linear pattern elements 91, taken along a line VII-VII in FIG. 6. In each of the linear pattern elements 91, the sectional shape (a section taken along a line VII-VII in FIG. 6) of each portion which is formed at the moving speed V2 of the outlets 412 is a trapezoid as shown in FIG. 7 and the sectional shape is almost similar to that of an opening of the outlet 412 seen from the (−Y) side toward the (+Y) direction. An average width of the section of this portion is about 90-μm. In the linear pattern elements 91, the maximum width of the gnarl portion 92 is about 200-μm, where width of clearance between two adjacent gnarl portions 92 arranged in the X direction is about 40-μm. The height of the linear pattern elements 91 formed on the substrate 9 is constant and it is about 150-μm. Geometric parameters of pattern such as width, height and pitch of the linear pattern elements 91, and width and pitch in the Y direction of the gnarl portions 92 may be changed appropriately. Manufacturing parameters such as the maximum value V2 and the minimum value V3 of moving speed of the plurality of the outlets 412 relative to the substrate 9, and the shape of the outlet 412 may be changed in accordance with a desired pattern to be formed.

When the outlets 412 of the ejection part 41 reach an end point for formation of pattern on the substrate 9, ejection of the patterning material is stopped (step S15). On the other hand, the substrate 9 continues to move in order to cure a portion of the patterning material which has been ejected in the vicinity of the end point. Thereafter, movement of the stage 20 is stopped (step S16) and also light irradiation is stopped, so that formation of the linear pattern elements 91 by the pattern forming apparatus 1 is finished (step S17).

After forming of the linear pattern elements 91, the substrate 9 is taken out from the pattern forming apparatus 1. The linear pattern elements 91 on the substrate 9 are burnt by another apparatus (at a temperature of approximately 500 degrees for 10 seconds, for example). The organic matter (the resin) contained in the patterning material is removed by the burning process and the low-melting glass frit fuses into solid masses.

After burning of the linear pattern elements 91 (ribs) is completed, phosphor layers are formed in a plurality of areas on the substrate 9 (i.e., a rear panel for a plasma display) which are defined by the rib pattern similar to parallel crosses. Thereafter, one glass substrate serving as a front panel for a plasma display is attached to the substrate 9 with the ribs interposed therebetween. For attachment of the front panel, first, a layer of glass having a low softening point which serves as an adhesive is formed on parts of the ribs of the substrate 9 which are to be in contact with the front panel (i.e., top surfaces of the linear pattern elements 91) and parts of the front panel which are to be in contact with the top surfaces of the linear pattern elements 91. Subsequently, the panel and the front panel are aligned with each other and preparatively secured to each other, and then are burnt to be firmly secured to each other.

A space between the substrate 9 and the front panel is partitioned into a plurality of discharge regions (i.e., cells) by the rib pattern similar to parallel crosses. Two adjacent ones of the discharge regions which are arranged side by side in the Y direction are continuous with each other via the clearance between two adjacent gnarl portions 92 arranged in the X direction, air is exhausted from each of the regions through the clearance, and thus gas such as xenon (Xe) is fed to each region. In the plasma display, application of a voltage to each of the discharge regions causes plasma discharge, so that ultraviolet rays are produced. Then, the ultraviolet rays are incident upon phosphor layers respectively formed in the discharge regions, to produce invisible light. In the plasma display, each of the plurality of discharge regions corresponds to one pixel. Additionally, a size of the clearance between two adjacent gnarl portions 92 arranged in the X direction is equal to or smaller than a predetermined size, which is small enough to prevent plasma generated in one of the discharge regions from moving to an adjacent discharge region.

As discussed above, in the pattern forming apparatus 1, the patterning material is ejected from the plurality of outlets 412 of the ejection part 41 and the outlets moving mechanism 44 operates as a gnarl portions formation part by changing moving speed of the plurality of outlets 412 relative to the substrate 9 periodically. By this operation, the plurality of gnarl portions 92 each of which spreads in a direction perpendicular to the direction extending the linear pattern elements 91 are formed in the plurality of linear pattern elements 91 at almost the same time at every specified time interval in forming the plurality of linear pattern elements 91. This makes it possible to form the plurality of gnarl portions 92 easily while ejecting the patterning material from the plurality of outlets 412, and it is possible to form the pattern similar to parallel crosses on the substrate 9 appropriately.

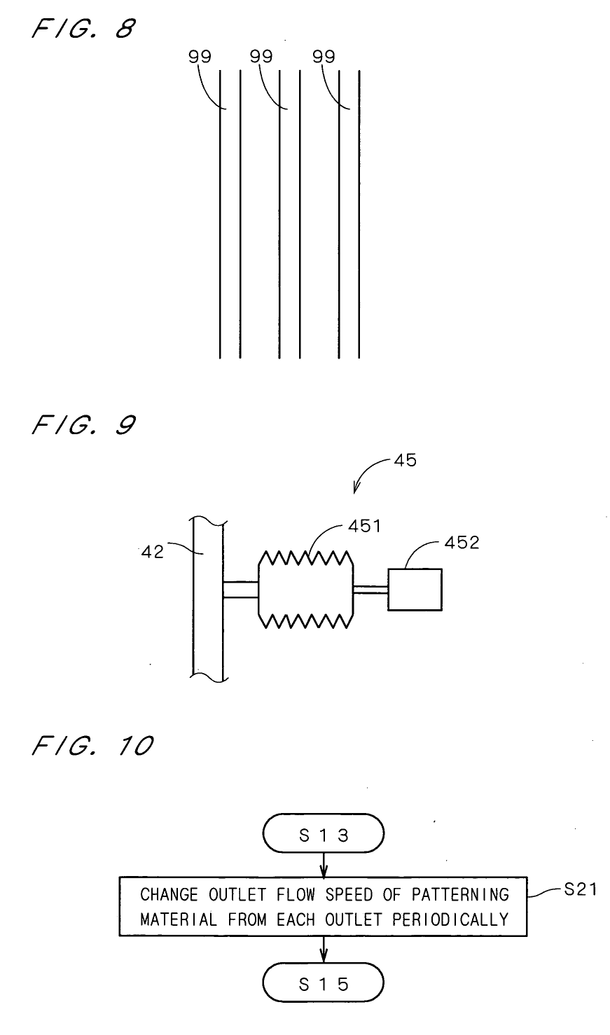

Discussion will be made on linear pattern elements 99 arranged in a pattern of stripes shown in FIG. 8, in comparison to the linear pattern elements 91 of FIG. 6. In the linear pattern elements 99 (ribs), each of cells can be exhausted in a relatively short time in supplying gas necessary for light emission to each of the cells, in one aspect. However, to arrange ribs in a pattern of stripes would require provision of a large non-light emitting area. Also, a surface area of a phosphor in each of the cells in a case where ribs are arranged in a pattern of stripes is smaller than in a case where ribs are arranged in parallel crosses. As such, ribs arranged in a pattern of stripes are difficult to improve a brightness of a plasma display. On the other hand, in the plurality of linear pattern elements 91 of FIG. 6 formed by the pattern forming apparatus 1 of FIG. 1, each of cells can be exhausted in a relatively short time through the clearance between two adjacent gnarl portions 92 arranged in the X direction. Also, for existence of the gnarl portions 92, a surface area of a phosphor in each of the cells in a case where the linear pattern elements 91 are arranged in a pattern similar to parallel crosses is larger than in a case where the linear pattern elements 99 are arranged in a pattern of stripes. Accordingly, it becomes possible to manufacture a plasma display having a high brightness panel.

The projecting member 413 is provided with the ejection part 41 and the projecting member 413 is in contact with the top of the patterning material on the substrate 9 ejected from each of the outlets 412. In this manner, the projecting member 413 which is a member to limit the height of the plurality of linear pattern elements 91 prevents the patterning material from being raised and it is therefore possible to form the gnarl portions 92 at the certain height steadily.

FIG. 9 is a view showing a constitution of a diaphragm part 45 provided with a pattern forming apparatus in accordance with the second preferred embodiment of the present invention. The diaphragm part 45 of FIG. 9 is connected to the supply pipe 42 which is located between the material supplier 43 and the ejection part 41 of FIG. 1. An outlets moving mechanism 44 is omitted in the pattern forming apparatus of the present preferred embodiment. The diaphragm part 45 comprises a bellows 451, one end of which is connected to the supply pipe 42 and the other end is closed. The closed end of the bellows 451 connects to a pushing mechanism 452 and the bellows 451 expands and contracts by movement of the pushing mechanism 452. By this operation, the outlet flow speed of the patterning material from each of the plurality of outlets 41 is changed.

FIG. 10 is a flow chart showing an operation flow of the pattern forming apparatus for forming a pattern on the substrate in accordance with the second preferred embodiment and it only shows the operation performing instead of step S14 of FIG. 4. In the pattern forming apparatus provided the diaphragm part 45 of FIG. 9, after starting movement of the substrate 9, ejection of the patterning material and light irradiation to the patterning material (FIG. 4: steps S11 to S13), in parallel with these operations, the diaphragm part 45 expands and contracts the bellows 451 periodically.

Specifically, when the diaphragm part 45 contracts the bellows 451 rapidly, pressure of the patterning material in the supply pipe 42 increases momentarily and the outlet flow speed of the patterning material from the outlets 412 increases temporarily. Subsequently, when the diaphragm part 45 expands the bellows 451 gradually, pressure of the patterning material in the supply pipe 42 is kept low and the patterning material is ejected from the outlets 412 at the constant outlet flow speed. The diaphragm part 45 repeats the above operation at specified time intervals, to change the outlet flow speed of the patterning material from the plurality of outlets 412 periodically (step S21).

At this time, since the moving speed of the substrate 9 by the stage moving mechanism 2 is constant, a ratio of outlet flow speed of the patterning material from each outlet 412 to moving speed of the plurality of outlets 412 relative to the substrate 9 is changed. As shown in FIG. 11, in each of the plurality of linear pattern elements 91, the height of that is limited by the projecting member 413 and the gnarl portions 92 each of which spreads in the direction (the X direction) perpendicular to the moving direction of the substrate 9 are arranged in the Y direction at the predetermined pitch. In the plurality of linear pattern elements 91, the plurality of gnarl portions 92 which are formed at almost the same time in forming the plurality of linear pattern elements 91 exist in almost the same position of the Y direction, and therefore a pattern similar to parallel crosses is formed on the substrate 9. In the linear pattern elements 91 of FIG. 11, each portion other than the gnarl portions 92 is formed at a certain width approximately, differing from the linear pattern elements 91 of FIG. 6.

When the outlets 412 of the ejection part 41 reach the end point for formation of pattern on the substrate 9 while forming the gnarl portions 92 periodically, ejection of the patterning material is stopped (FIG. 4: step S15). Subsequently, movement of the stage 20 and light irradiation are stopped, so that formation of the linear pattern elements 91 by the pattern forming apparatus 1 is finished (steps S16 and S17).

As discussed above, in the pattern forming apparatus comprising the diaphragm part 45 of FIG. 9, the patterning material is ejected from the plurality of outlets 412 of the ejection part 41 and the diaphragm part 45 operates as a gnarl portions formation part which changes the outlet flow speed of the patterning material from each outlet 412 periodically. This makes it possible to form the plurality of gnarl portions 92 easily while ejecting the patterning material from the plurality of outlets 412, and it is possible to form the pattern similar to parallel crosses on the substrate 9 appropriately.

Next, a pattern forming apparatus in accordance with the third preferred embodiment of the present invention will be discussed. In the embodiment, as shown in FIG. 12, an irradiation intensity change part 54 is provided between the light source unit 53 and the light emitting part 51. The irradiation intensity change part 54 comprises a shutter which is allowed to open and close at high speeds.

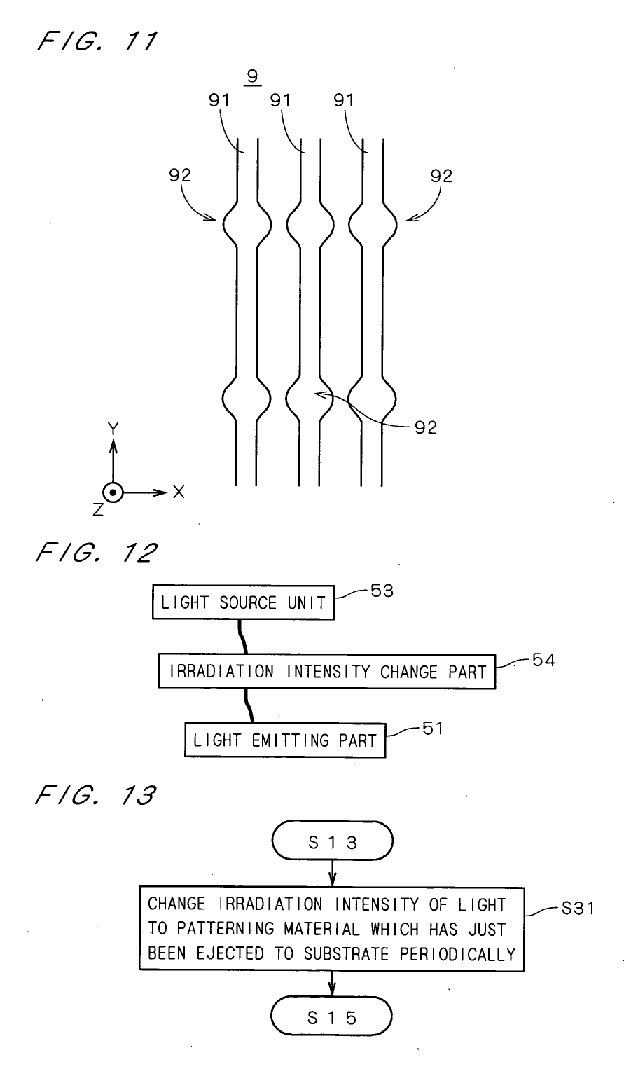

FIG. 13 is a flow chart showing an operation flow of the pattern forming apparatus for forming a pattern on the substrate in accordance with the third preferred embodiment and it only shows the operation performing instead of step S14 of FIG. 4. In the pattern forming apparatus provided the irradiation intensity change part 54, after starting movement of the substrate 9, ejection of the patterning material and light irradiation to the patterning material (FIG. 4: steps S11 to S13), in parallel with these operations, an irradiation intensity (or irradiation volume) of light to the patterning material which has just been ejected to the substrate 9 is changed periodically (step S31).

Specifically, light which is irradiated to the patterning material from the light source unit 53 through the light emitting part 51 is intercepted temporarily by closing the shutter periodically for a short time by the irradiation intensity change part 54. Accordingly, while the irradiation intensity change part 54 opens the shutter, light is irradiated to the patterning material which has just been ejected to the substrate 9, the height of the linear pattern elements 91 is limited by the projecting member 413, and then the linear pattern elements 91 are formed at a predetermined width. On the contrary, while the irradiation intensity change part 54 closes the shutter, light is not irradiated to the patterning material which has just been ejected to the substrate 9, the patterning material is thus affected by gravity, and it goes down and collapses. Thus, each of the patterning material spreads in the direction (i.e., the X direction) approximately perpendicular to the moving direction of the substrate 9. Thereafter, the shutter is opened, light is irradiated to collapsed portions of the patterning material, and the gnarl portions 92 are formed in the linear pattern elements 91, the height of which is lower than other portions.

ON/OFF of light irradiation to the patterning material is controlled by the irradiation intensity change part 54 and the plurality of gnarl portions 92 arranged in the X direction in the plurality of linear pattern elements 91 are formed at almost the same time at every specified time interval in forming the plurality of linear pattern elements 91, like FIG. 11. When the linear pattern elements 91 are formed in all areas of the substrate 9, movement of the substrate 9, ejection of the patterning material, and light irradiation are stopped, so that formation of the linear pattern elements 91 by the pattern forming apparatus is finished (FIG. 4: steps S15 to S17).

As discussed above, in the pattern forming apparatus comprising the irradiation intensity change part 54 of FIG. 12, the patterning material is ejected from the plurality of outlets 412 of the ejection part 41 and the irradiation intensity change part 54 operates as a gnarl portions formation part which periodically changes the irradiation intensity of light to the patterning material which has just been ejected to the substrate 9. This makes it possible to form the plurality of gnarl portions 92 easily while ejecting the patterning material from the plurality of outlets 412, and it is possible to form the pattern similar to parallel crosses on the substrate 9 appropriately. If the shutter provided in the light source unit 53 is allowed to open and close at high speeds, ON/OFF of light irradiation to the patterning material may be controlled by using this shutter instead of the irradiation intensity change part 54.

A light intensity change filter which is rotatable is provided with the irradiation intensity change part 54 instead of the shutter and the irradiation intensity of light to the patterning material may be changed periodically. If viscosity of the patterning material is relatively high or the like, a mask is provided between the light emitting part 51 and the patterning material on the substrate 9, and light may be irradiated to portions other than portions corresponding to the gnarl portions 92 in the patterning material on the substrate 9 by emitting pulsed light from the light source unit 53 at specified time intervals. This produces substantially the same light irradiation to the patterning material as the irradiation intensity change part 54. To form the plurality of gnarl portions 92 in the linear pattern elements 91 more easily, it is preferable to only perform ON/OFF control of light irradiation to the patterning material ejected to the substrate 9.

Though the preferred embodiments of the present invention has been discussed above, the present invention is not limited to the above-discussed preferred embodiments, but allows various variations.

In the above first preferred embodiment, the outlets moving mechanism 44 need not be a cam mechanism for rotating the ejection part 41 and it may be a mechanism for moving the ejection part 41 straight, for example. Also, the outlets moving mechanism 6 may be omitted. In this case, the controller 6 periodically changes moving speed of the substrate 9 by controlling the stage moving mechanism 2, the gnarl portions 92 are formed at the predetermined pitch in each of the linear pattern elements 91, and the plurality of gnarl portions 92 which are formed at almost the same time are arranged in almost the same position in the plurality of linear pattern elements 91.

In the above second preferred embodiment, the diaphragm part 45 may be other than the one which comprises a bellows. According to required accuracy of the linear pattern elements 91 formed on the substrate 9, the outlet flow speed of the patterning material from each outlet 412 may be changed periodically by controlling a pump of the material supplier 43 for ejection of the patterning material.

In the above preferred embodiments, since the clearance exists between the two adjacent gnarl portions 92 arranged in the X direction, each of the cells can be exhausted efficiently while supplying gas necessary for light emission to each of the cells. In the glass substrate 9 of the plasma display, no clearance needs to be made between the two gnarl portions 92 by lowering the height of the gnarl portions 92 or the like if it does not cause problems in exhausting each of the cells.

In the pattern forming apparatus, movement of the ejection part 41 relative to the substrate 9 may be performed by fixing the substrate 9 and only moving the ejection part 41 in the Y direction. In cases where the number of the linear pattern elements 91 which must be formed on one substrate 9 is more than that of the outlets 412 of the ejection part 41, a mechanism for moving the head 3 relative to the substrate 9 in the X direction is provided and formation of the linear pattern elements 91 is repeated.

The above-described pattern forming apparatus is useful to form ribs in other types of flat panel displays such as an organic electroluminescence (EL) display and a liquid crystal display, or other patterns. Also, the substrate 9 is not limited to a glass substrate, and may be a resin substrate, a semiconductor substrate, or the like.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-326153 filed in the Japan Patent Office on Nov. 10, 2004, the entire disclosure of which is incorporated herein by reference.

What is claimed is:

1. A pattern forming method for forming a pattern on a substrate, comprising the steps of:
a) ejecting a patterning material from a plurality of outlets to a main surface of a substrate;
b) forming a plurality of linear pattern elements each of which extends in a predetermined direction along said main surface by moving said plurality of outlets relative to said substrate in said predetermined direction in parallel with said step a); and
c) forming gnarl portions in each of said plurality of linear pattern elements in parallel with said step b), each of said gnarl portions spreading in a direction perpendicular to said predetermined direction, wherein
a plurality of gnarl portions arranged in a direction perpendicular to said predetermined direction in said plurality of linear pattern elements are formed at almost the same time at every specified time interval in forming said plurality of linear pattern elements in said step c).

2. The pattern forming method according to claim 1, wherein
said plurality of gnarl portions are formed by changing a ratio of outlet flow speed of said patterning material from each of said plurality of outlets to moving speed of said plurality of outlets relative to said substrate in said step c).

3. The pattern forming method according to claim 2, wherein
said outlet flow speed of said patterning material is constant in said step a), and
said moving speed of said plurality of outlets is changed periodically in said step c).

4. The pattern forming method according to claim 2, wherein
said moving speed of said plurality of outlets is constant in said step b), and
said outlet flow speed of said patterning material is changed periodically in said step c).

5. The pattern forming method according to claim 1, wherein
said pattering material contains a light-curing resin, and
an irradiation intensity of light to said patterning material which has just been ejected to said substrate is changed periodically in said step c).

6. The pattern forming method according to claim 5, wherein
said irradiation intensity of light is changed periodically by performing ON/OFF control of light irradiation to said patterning material ejected to said substrate in said step c).

7. A pattern forming apparatus for forming a pattern on a substrate, comprising:
an ejection part for ejecting a patterning material from a plurality of outlets to a main surface of a substrate; and
a moving mechanism for forming a plurality of linear pattern elements each of which extends in a predetermined direction along said main surface by moving said ejection part relative to said substrate in said predetermined direction in parallel with ejection of said patterning material from said ejection part, wherein
gnarl portions exist in each of said plurality of linear pattern elements, each of said gnarl portions spreads in a direction perpendicular to said predetermined direction, and a plurality of gnarl portions arranged in a direction perpendicular to said predetermined direction in said plurality of linear pattern elements are formed at almost the same time at every specified time interval in forming said plurality of linear pattern elements.

8. The pattern forming apparatus according to claim 7, wherein
said plurality of gnarl portions are formed by changing a ratio of outlet flow speed of said patterning material from each of said plurality of outlets to moving speed of said plurality of outlets relative to said substrate.

9. The pattern forming apparatus according to claim 8, wherein
said outlet flow speed of said patterning material is constant, and
said moving speed of said plurality of outlets is changed periodically.

10. The pattern forming apparatus according to claim 8, wherein
said moving speed of said plurality of outlets is constant, and
said outlet flow speed of said patterning material is changed periodically.

11. The pattern forming apparatus according to claim 7, wherein
said pattering material contains a light-curing resin, and
said plurality of gnarl portions are formed by changing an irradiation intensity of light to said patterning material which has just been ejected to said substrate.

12. The pattern forming apparatus according to claim 11, wherein
said irradiation intensity of light is changed periodically by performing ON/OFF control of light irradiation to said patterning material ejected to said substrate.

13. The pattern forming apparatus according to claim 7, wherein
said ejection part comprises a member being in contact with a top of a patterning material on a substrate ejected from each of said plurality of outlets to limit height of said plurality of linear pattern elements.

14. The pattern forming apparatus according to claim 8, wherein
said ejection part comprises a member being in contact with a top of a patterning material on a substrate ejected from each of said plurality of outlets to limit height of said plurality of linear pattern elements.
